(19) United States
(12) Patent Application Publication
(10) Pub. No.: US 2007/0138891 A1
(43) Pub. Date: Jun. 21, 2007

(54) Magnet retention and positioning sleeve for surface mounted rotor assemblies

(75) Inventor: Dennis M. Hurst, Florissant, MO (US)

Correspondence Address: SENNIGER POWERS, ONE METROPOLITAN SQUARE, 16TH FLOOR, ST LOUIS, MO, 63102, US

(73) Assignee: Emerson Electric Co., St. Louis, MO (US)

(21) Appl. No.: 11/311,739

(22) Filed: Dec. 19, 2005

(51) Int. Cl. H02K 21/12; H02K 1/27

(52) U.S. Cl. 310/156.28

(57) ABSTRACT

A rotor assembly for a motor includes a rotor core having an outer surface and a plurality of magnets engaging the outer surface of the rotor core. Each magnet has an inner surface shaped to conform to the outer surface of the rotor core. An aluminum sleeve receives the magnets and core, and the sleeve includes integrally formed ribs extending inwardly from an inner surface of the sleeve to the core. The ribs define cavities therebetween for receiving the magnets. Methods of making the assembly are also disclosed.

### BACKGROUND OF THE INVENTION

This invention relates generally to brushless permanent magnet (BPM) motors, and more particularly to such motors including magnets mounted on a surface of a rotor core.

One type of permanent magnet motor includes a plurality of magnets mounted on the surface of the rotor core. A major challenge for surface mounted magnets is accurately positioning the magnets and thereafter retaining the magnets in the rotor assembly. Many prior art solutions, such as steel sleeves and magnaformed aluminum sleeves, involve expensive tooling and manufacturing processes. Also, prior art magnet retainers tend to be too sensitive to temperature and environment and/or too expensive for many motor applications. Accordingly, there is a need for a less expensive and less temperature sensitive rotor assembly for a permanent magnet motor.

### SUMMARY OF THE INVENTION

In one aspect, a rotor assembly for a motor comprises a rotor core having an outer surface and a plurality of magnets engaging the outer surface. An aluminum sleeve receives the magnets and core, and the sleeve includes integrally formed ribs extending inwardly from an inner surface of the sleeve to the core. The ribs define cavities therebetween for receiving the magnets.

In another aspect, a method of making a rotor assembly for a brushless permanent magnet motor comprises forming an aluminum sleeve having an outer surface, inner surface and spaced-apart ribs extending inwardly from the inner surface. The space between the ribs defines magnet-receiving cavities and the ribs are formed integrally with the inner surface. The method further comprises placing a magnet into each of the cavities, positioning a rotor core in the sleeve and securing the core and magnets within the sleeve. The method also comprises magnetizing the rotor assembly.

Various refinements exist of the features noted in relation to the above-mentioned aspects of the present invention. Further features may also be incorporated in the above-mentioned aspects of the present invention as well. These refinements and additional features may exist individually or in any combination. For instance, various features discussed below in relation to any of the illustrated embodiments of the present invention may be incorporated into any of the above-described aspects of the present invention, alone or in any combination.

### BRIEF DESCRIPTION OF THE DRAWINGS

FIG. 1 is a perspective exploded view of a rotor assembly of one embodiment of the invention;

FIG. 2 is a perspective view of the rotor assembly;

FIG. 3 is a perspective exploded view of a rotor assembly of another embodiment along with a rotor shaft;

FIG. 4 is a perspective view of the rotor assembly and shaft of FIG. 3 and a stator assembly; and

FIG. 5 is a perspective view of the joined rotor assembly and stator assembly of FIG. 4.

Corresponding reference characters indicate corresponding parts throughout the drawings.

### DETAILED DESCRIPTION OF THE ILLUSTRATED EMBODIMENTS

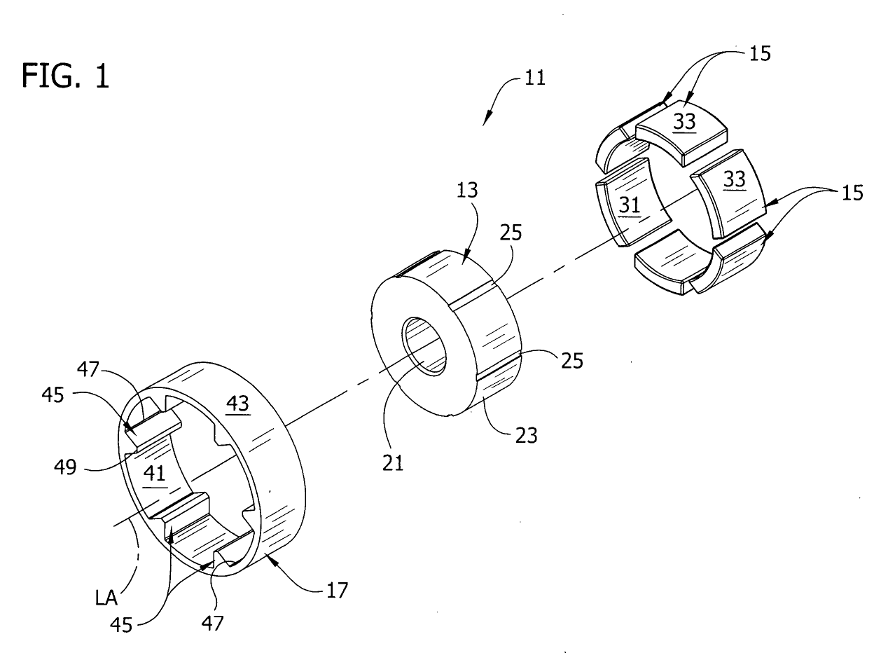

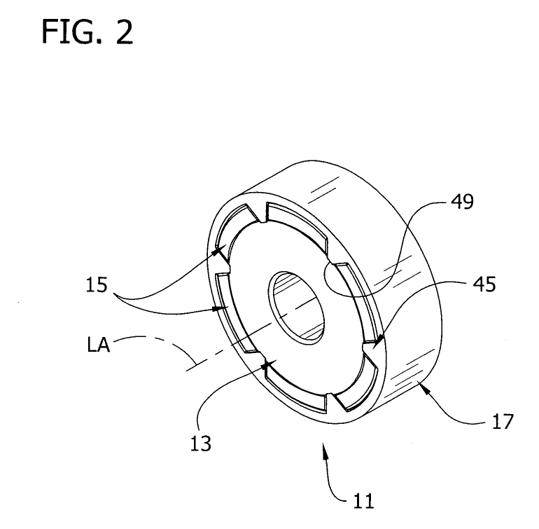

Referring to FIGS. 1 and 2, a rotor assembly of one embodiment of the invention is generally designated 11. The assembly comprises a rotor core designated 13, a plurality of arcuate-shaped magnets designated 15 (six are shown, but any number may be used within the scope of the invention), and an aluminum sleeve designated 17. The aluminum sleeve receives the magnets 15 and the core 13, and these three elements are secured together in an assembly as described in detail below. These elements may have other shapes and configurations within the scope of the invention. The rotor assembly 11 may be used in a variety of BPM motors that have magnets mounted on the surface of the rotor core 13.

The rotor core 13 of this embodiment is generally cylindrical, being ring-shaped in cross-section having a circular opening 21 that is coaxial with a longitudinal axis LA of the core. The core 13 has a cylindrical outer surface 23 that optionally includes longitudinally extending recesses 25. The recesses may have a variety of other sizes and shapes within the scope of the invention. The recesses may be omitted altogether so that the outer surface 23 is smooth and continuous. In other embodiments, the core may have protrusions extending therefrom that facilitate engagement with the sleeve as described below. The rotor core 13 may be made of any ferromagnetic material, including powdered metal, among other possible materials. The core may also be made of stacked individual stampings or of a turned solid (e.g., iron).

The magnets 15 engage the cylindrical outer surface 23 of the rotor core 13. Each magnet 15 of this embodiment has a curved (e.g., partially circular) inner surface 31 generally conforming to the outer surface 23 of the core 13, and a similarly curved outer surface 33 generally conforming to a curve of the sleeve 17. Each magnet 15 may be of other shapes, e.g., the inner and outer surfaces may be curved or straight. Each magnet may also be made of many different materials, including any ferrite, sintered neodymium iron (Nd—Fe—B) alloy, among other possible materials.

The aluminum sleeve 17 of this embodiment is tubular, having an inner surface 41 and an outer surface 43, and has the shape of a right circular cylinder. The sleeve 17 may have other shapes within the scope of the invention. The longitudinal axis LA of the sleeve 17 is coaxial with that of the core 13. The sleeve 17 includes integrally formed ribs designated 45 (generally, projections) that extend radially inwardly from the inner surface 41 of the sleeve 17 to the core 13. The ribs 45 define cavities therebetween for receiving and for accurately positioning the magnets 15. In this embodiment, the ribs 45 extend generally continuously along the length of the sleeve 17. However, the ribs 45 may alternatively be discontinuous or extend less than the full length of the sleeve 17. Also, the ribs 45 may alternatively have a uniform thickness, but are generally stronger when formed as shown, i.e., tapered from their base 47 to their ends 49. In this embodiment, the length of the ribs 45 is chosen so that ends of the ribs are received in the recesses 25 and at least partially contact the core 13. Such configuration inhibits or prevents rotation or axial movement of the sleeve. However, the length of the ribs 45 may vary. In other embodiments, the length may be such that ends 49 of the ribs 45 are spaced somewhat from the core 13, e.g., where rib length is limited by fabrication or extrusion constraints. Such ribs still serve to locate and position the magnets. The ends 49 of the ribs 45 may also be sized and shaped to conform to features or projections extending from the core 13, and may either contact or be spaced from the core.

Some possible methods of making the rotor assembly 11 will be described, though other methods are contemplated within the scope of the invention. In one embodiment, an aluminum sleeve 17 is formed by first cutting a thick walled (at least about 3-4 mm thick) aluminum tube to a predetermined length. The thickness may vary, for example, due to length of the ribs, the magnet thickness, or due to limits of the broaching operation. Note the aluminum sleeve 17 may be, for example, any commercially available aluminum stock material. A broaching operation is then performed on the tube to remove material from the inner surface such that the ribs 45 are formed to extend radially inwardly from the inner surface 41 of the sleeve 17.

Alternatively, an extrusion process is performed on aluminum stock material (e.g., round tubular material) using an appropriately shaped extrusion tool in an extrusion machine. In one embodiment, the sleeve 17 is cut to length after the material is extruded. The extrusion process is capable of accurately forming the ribs 45 (as described above) extending from the inner surface 41 of the sleeve 17. However, the sleeve 17 may be further improved (e.g., tolerances of the ribs in the sleeve may be further reduced) by following the extrusion process with a secondary broaching operation. Both the broaching and extrusion operations are relatively quick and cost-effective in that they do not require expensive tooling. Both operations form the sleeve 17 from a single piece of material so that the ribs 45 are integral with the inner surface 41 of the sleeve 17.

Each magnet 15 is placed into respective cavities between the ribs 45, and the core 13 is positioned in the sleeve 17. The order of these two steps may depend in part on what type of securing step (as described below) is chosen.

The spacing between the ribs 45 may be designed for an interference fit such that each magnet 15 must be pressed into the respective cavity. Alternatively, the ribs 45 may be spaced for a looser slip fit, in which case the magnets 15 are slipped into the cavities. Optionally, adhesive may be applied to the magnets 15 to secure them to the sleeve 17 during the assembly process. As will be understood, the ribs 45 serve to accurately locate and position the magnets 15 so as to eliminate many prior art fixturing arrangements.

There are a number of ways of securing the core 13, the magnets 15 and the sleeve 17 together. In one embodiment, the securing step includes heating the magnets 15 and sleeve 17 after the magnets have been placed in the cavities but prior to positioning the core 13 in the sleeve. The heating expands the magnets 15 and sleeve 17 so that they can be slipped over the core 13. Thereafter the magnets 15 and sleeve 17 are allowed to cool so that so that the sleeve shrinks, thereby forcing the ribs 45 and/or the magnets against the core 13 to thereby secure the assembly together.

The securing step may also include, in combination with the heat shrink step or by itself, pressing the sleeve 17, the magnets 15 and the core 13 into engagement with one another. Such a step may be performed using a press (e.g., an arbor press), and may force the ends 49 of the ribs 45 into engagement with the core 13 and/or may force the magnets 15 into engagement with the core. Where the sleeve and magnets are first assembled into a subassembly, for example, and there is an interference fit between the rib ends and the core, the press may apply force axially to force the subassembly onto the core. During pressing, there may be a radial component of reaction force from the core due to interference of the rib ends with the core and resulting friction. Other ways of forcing the ribs 45 toward the core 13 or into engagement with the core are contemplated within the scope of the invention.

Optionally, adhesive may be applied to the magnets 15 or to the core 13, before or after they are positioned or placed within the sleeve 17, to inhibit relative motion between the magnets 45 and the core. End caps or end plates (not shown) may optionally be secured over one or both ends of the sleeve 17. Alternatively, ends of the aluminum sleeve 17 (e.g., the ribs 45) or the core 13 may be “swaged” or deformed around ends of the magnets 15 to further secure the magnets. Such swaging may be particularly advantageous where some amount of space should be provided between the magnets 15 and the sleeve 17. This is particularly helpful in applications where the motor will experience a wide range of temperatures that will cause the magnet 15 and sleeve 17 to expand and shrink. Such spacing can inhibit damage to the sleeve 17 and the magnets 15.

The outer surface 43 of the sleeve 17 is also machined or “turned” to reduce a diameter of the outer surface to a predetermined diameter. This step is typically performed after the securing step. The predetermined diameter may be chosen based on a variety of factors, including without limitation the requirements of the electromagnetic design, the structural requirements for compression of the magnets 15 and the required temperature range of the application. The rotor assembly 11 is also magnetized, typically after the sleeve 17 is machined.

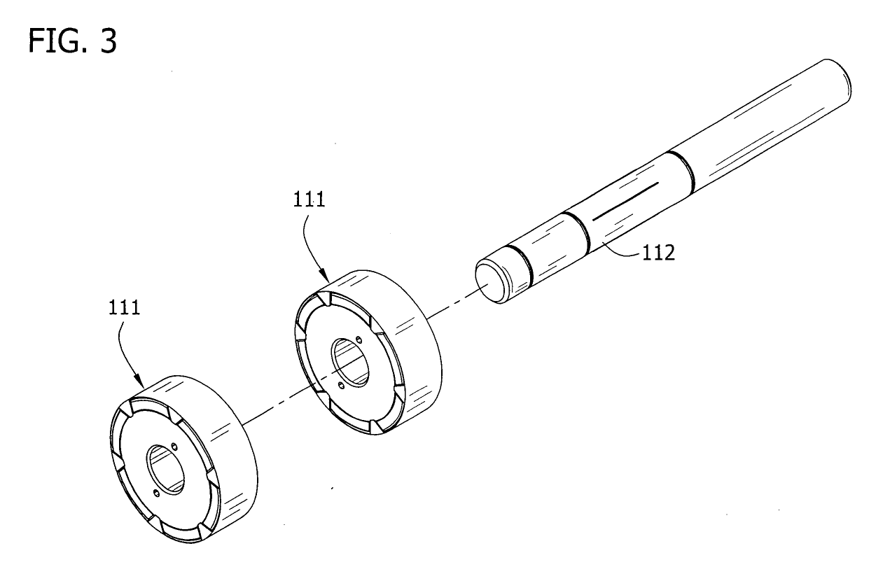

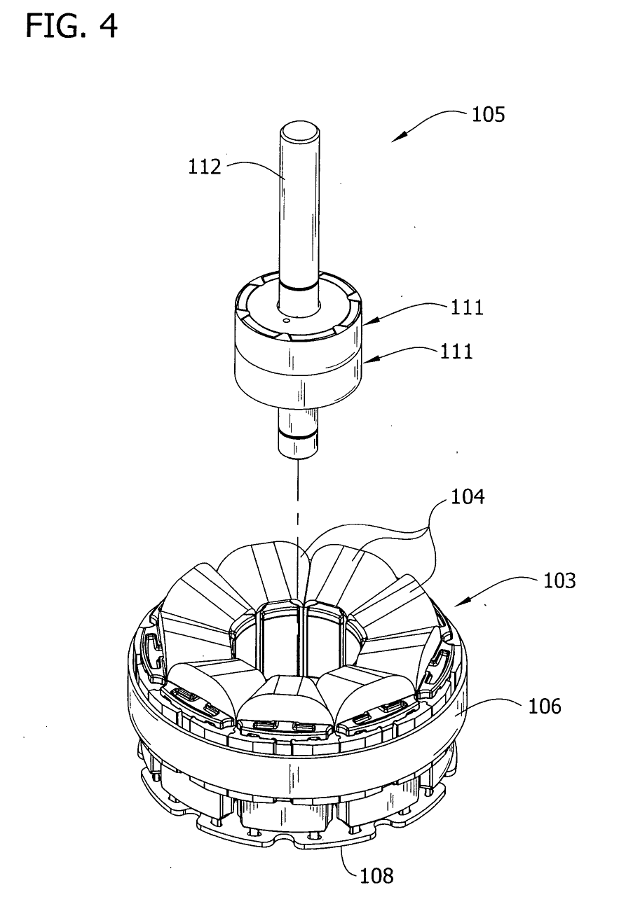

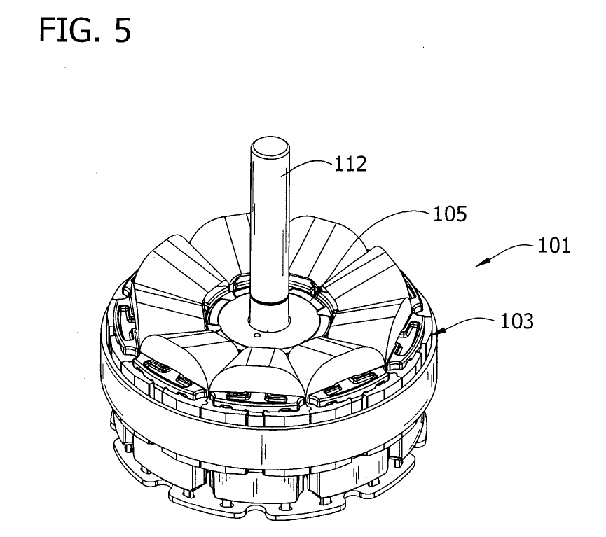

In another embodiment shown in FIGS. 3-5, a motor 101 comprises a “step-skewed” rotor 105 joined with a stator assembly 103. As shown in FIG. 3, the rotor 105 includes two rotor assemblies 111 substantially identical to one another but angularly offset when mounted on the shaft 112 so that the magnetic axes of the respective assemblies are angularly offset from one another. In this way, the rotor 105 is axially skewed or “step-skewed.” This rotor 105 can result in less cogging torque and/or make the distribution of magnetic flux that links the stator coils more nearly sinusoidal.

The rotor assemblies 111 can be made as described above with respect to assembly 11. The segmented stator assembly 103 of this embodiment includes a plurality (nine are shown) of “teeth” or segments 104 and held together by an arcuate band 106. A printed circuit board 108 is mounted on an end of the stator. Other configurations for the components of the motor 101 are contemplated.

The rotor core 13 may be used in a variety of BPM motors having magnets 15 mounted on the surface of the rotor core and is particularly useful for small diameter rotor cores (e.g., less than about 3 inches or about 76 mm). Such motors may be used in a variety of applications, including without limitation appliances, automotive, commercial and industrial. Many embodiments of the invention are advantageous because they accurately position the magnets 15 and securely retain the magnets thereafter. Moreover, many embodiments of the invention provide a motor with low “cogging”. The rotor assembly 11 is less expensive to produce than prior art rotor assemblies because the aluminum sleeve 17 can be produced to close tolerances with inexpensive tooling, especially as compared to steel sleeves. Moreover, the rotor sleeve can eliminate the need for separate magnet fixturing tools or locating features. Accordingly, capital expenditures for manufacturing the motor are reduced. Indeed, some embodiments of the assembly can be “bench assembled.”

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

1. A rotor assembly for a motor comprising:
a rotor core having an outer surface;
a plurality of magnets engaging the outer surface of the rotor core, each magnet having an inner surface shaped to conform to the outer surface of the rotor core;
an aluminum sleeve receiving the magnets and core, the sleeve including integrally formed ribs extending inwardly from an inner surface of the sleeve to the core, the ribs defining cavities therebetween for receiving the magnets, each rib tapering as it extends inwardly from the inner surface of the sleeve such that a base of each rib is wider than its inward end.

2. The rotor assembly of claim 1 wherein ends of at least some of the ribs contact the core.

3. The rotor assembly of claim 1 wherein the outer surface of the core includes a plurality of axially extending recesses, each recess receiving an inward end of one of the ribs to further secure the sleeve and magnets to the core.

4. The rotor assembly of claim 3 wherein the sleeve is a right circular cylinder and the outer surface is cylindrical.

5. The rotor assembly of claim 3 wherein a longitudinal axis of the rotor core is generally coaxial with a longitudinal axis of the sleeve.

6. The rotor assembly of claim 3 in combination with the motor.

7. The combination of claim 6 further comprising a second substantially identical rotor angularly offset from the first referenced rotor assembly.

8-19. (canceled)

20. A motor comprising:
a rotor assembly including:
a rotor core having an outer surface;
a plurality of magnets engaging the outer surface of the rotor core, each magnet having an inner surface shaped to conform to the outer surface of the rotor core;
an aluminum sleeve receiving the magnets and core, the sleeve including integrally formed ribs extending inwardly from an inner surface of the sleeve to the core, ends of at least some of the ribs contacting the core, the ribs having a generally triangular cross section with an inward end being truncated to engage the core;
the outer surface of the core including a plurality of axially extending recesses, each recess receiving the truncated end of one of the ribs to further secure the sleeve and magnets to the core.

21. The motor of claim 20 wherein the sleeve is a right circular cylinder and the outer surface is cylindrical.

22. The motor of claim 21 wherein a longitudinal axis of the rotor core is generally coaxial with a longitudinal axis of the sleeve.

23. The motor of claim 20 further comprising a second substantially identical rotor assembly angularly offset from the first referenced rotor assembly.

24. The rotor assembly of claim 1 wherein the sidewalls of the ribs taper from the base to the top.

25. The rotor assembly of claim 1 wherein the ribs are shaped so that the ribs do not interlock with the core.

26. The rotor assembly of claim 20 wherein the ribs do not interlock with the core.

27. A motor comprising:
a rotor assembly including:
a rotor core having an outer surface,
a plurality of magnets engaging the outer surface of the rotor core,
each magnet having an inner surface shaped to conform to the outer surface of the rotor core,
an aluminum sleeve receiving the magnets and core,
the sleeve including integrally formed ribs extending inwardly from an inner surface of the sleeve to the core,
inward ends of at least some of the ribs contacting the core,
the outer surface of the core including a plurality of axially extending recesses,
each recess receiving the inward end of one of the ribs to further secure the sleeve and magnets to the core,
and wherein the ribs do not interlock with the core.

28. The motor of claim 27 wherein the sleeve is a right circular cylinder and the outer surface is cylindrical.

29. The motor of claim 28 wherein a longitudinal axis of the rotor core is generally coaxial with a longitudinal axis of the sleeve.

30. The motor of claim 29 further comprising a second substantially identical rotor assembly angularly offset from the first referenced rotor assembly.
